(19) United States
(12) Patent Application Publication
(10) Pub. No.: US 2020/0159865 A1
(43) Pub. Date: May 21, 2020

(54) ENHANCED UNIFORM RESOURCE LOCATOR PREVIEW IN MESSAGING

(71) Applicant: T-Mobile USA, Inc., Bellevue, WA (US)

(72) Inventor: Vinod Ravichandran, Renton, WA (US)

(21) Appl. No.: 16/196,924

(22) Filed: Nov. 20, 2018

(51) Int. Cl. G06F 17/30; G06F 17/21; H04L 12/58; G06F 17/22

(52) U.S. Cl. CPC G06F 17/30887; G06F 17/212; G06F 17/30952; G06F 17/2247; H04L 51/08

(57) ABSTRACT

Techniques are described herein for generating previews for uniform resource locators (URLs) referring to various content such as websites. A request to share a link to a URL is received from a remote user equipment. The URL can refer to a website that includes markup language information with defined content fields. The content fields can correspond to at least one website content such as a URL, a title, a description, and an image. This content and information can be selected to be used for generating a preview of the URL. The preview of the URL can be displayed with the shared link using a messaging application.

### BACKGROUND

A wide variety of messaging systems have become ubiquitous tools for general communication with the expansion of cellular, WiFi, cable, fiber, and other network access points and the growing use and availability of network-enabled mobile devices such as smartphones. Early messaging systems such as Short Message Service (SMS) limits users to a certain number of characters, preventing the users from sending or receiving lengthy messages. Additionally, SMS text messaging does not support sending media, such as videos and pictures. In contrast, current messaging systems are capable of propagating video, audio, images, and uniform resource locators (URLs) of a variety of different content among users.

In this regard, digital content is most often shared in the form of a website. A website can comprise a significant amount of information that can be extremely time-consuming to inspect and process. Thus, providing summarized information or previews of the content on websites to entice users to click on links to the URLs is desirable. To generate previews, website content must be publicly available and properly tagged or identifiable. Without a standardized configuration for tagging publicly available content, generating previews for URLs cannot be achieved in a harmonious and systematic manner. Accordingly, an inconsistent presentation of URL previews across different user equipment can lead to poor user experiences.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates an example network architecture for generating a URL preview for display in incoming messages in the messaging application.

FIG. 2 is a block diagram showing various components of an illustrative computing device that implements a URL preview tool.

FIG. 3 is a lookup table showing defined content fields corresponding to one or more parsed content of a website.

FIG. 4 is an example graphical user interface of a messaging application showing a generated URL preview in an incoming message.

FIG. 5 is a flow diagram of an example process for generating URL previews for display in a user interface of a messaging application operating on a user equipment.

### DETAILED DESCRIPTION

This disclosure is directed to techniques for displaying a preview for a URL received in an incoming message via a messaging application. In various embodiments, this disclosure can be applied on wireless and wire-based networks that are capable of supporting one or more user equipment comprising, for example, a mobile device, a cell phone, a phablet, and/or so forth. The user equipment is configured to receive an incoming message comprising a URL via a messaging application, wherein the URL refers to a website or a webpage written using hypertext markup language (HTML) or other markup language. The user equipment can be in communication with an application server comprising a URL preview tool, whereby the URL preview tool can identify the URL in the incoming message. The identified URL can be validated to ensure that the URL does not refer to a website that does not exist, or that the URL is not badly formed or contains invalid characters.

Upon validating the URL, the URL preview tool can implement web scraping or crawling techniques in order to obtain and cache content of the website referenced in the URL. More particularly, the URL preview tool can retrieve markup language information such as HTML of the website. The HTML utilizes proper fields for sharable or published content. Thus, the URL preview tool can parse the HTML in order to identify and extract relevant information such as a predetermined list of tagged website content or content fields. For instance, the content fields can comprise the URL, a title of the website, a description of the website (e.g., a snippet), and an image (e.g., a header image, a thumbnail image, a favicon, etc.). Parsed content that is publicly available and identified via the URL preview tool can be used to generate and display a preview of the shared URL in the messaging application. If the website is restricted or the content is not public, the URL preview tool is configured to obtain relevant content for display in a preview upon, for example, receiving authorization (e.g., whitelisting the URL preview tool) from a web server hosting the website.

In various embodiments, the messaging application can configure the visual presentation of a URL preview in order to deliver a consistent representation of the URL preview across different user equipment and users. In this regard, the URL preview tool can specify the type of content that the messaging application can display, and the messaging application presents the URL preview in a predetermined format depending on the content available. Alternatively, or additionally, the URL preview tool configures a visual format of the URL preview and propagates the URL preview generated using the visual format to one or more user equipment for display via the messaging application. The visual format can be at least partially based on the user equipment type, capabilities, messaging application type and/or available subscriber plan, depending on embodiments. In this way, slow data connection or low data allowance may change the resolution of an image in the URL preview. The techniques described herein may be implemented in a number of ways. Example implementations are provided below with reference to the following figures.

### Example Network Architecture

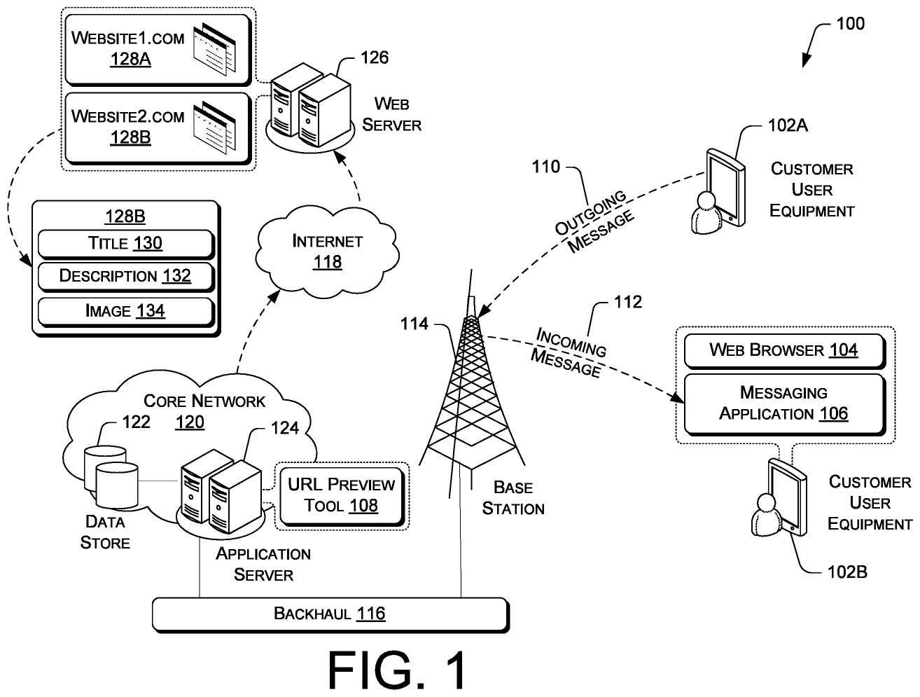

FIG. 1 illustrates example network architecture for receiving incoming messages via a messaging application and generating a URL preview in the messaging application. For example, the exemplary network 100 can be a cellular network that implements 2G, 3G, 4G, and long-term evolution (LTE), LTE advanced, high-speed data packet access (HSDPA), evolved high-speed packet access (HSPA+), universal mobile telecommunication system (UMTS), code-division multiple access (CDMA), global system for mobile communications (GSM), WiMax, and WiFi access technologies. In various embodiments, the network 100 can also be packet networks, Internet protocol (IP) networks, Public Switched Telephone Networks (PSTN), wireless networks, various access networks, and/or so forth. In this regard, the present disclosure is not limited to a particular type of network.

The network 100 comprises one or more base stations 114 in communication with the core network 120 via portions of a network backhaul 116 and/or via other distributed portions of the network. The network 100 also includes an over-the-air (OTA) interface that facilitates radio communications (e.g., wireless Internet Protocol (IP) data and SMS communications) between a telecommunications service provider and one or more user equipment 102A-102B via the network base station 114. The core network 120 can comprise one or more network elements that may serve as gateway devices (e.g., servers or edge routers) for the core network 120. For example, the core network 120 can comprise an application server 124 and a data store 122 or a database comprising any electronic collection of data such as customer account information. The data store 122 can comprise a data management layer that includes software utilities for facilitating the acquisition, processing, storing, reporting, and analysis of data from multiple data sources. In various embodiments, the data store 122 can interface with an API for providing data access.

The application server 124 can include any general-purpose computers, such as desktop computers, tablet computers, laptop computers, servers (e.g., on-premise servers), or other electronic devices that are capable of receiving inputs, processing the inputs, and generating output data. The application server 124 may be operated by the telecommunications service provider or a third-party entity that is working with the telecommunications service provider. The application server 124 may store data in a distributed storage system (e.g., the data store 122), in which data may be stored for long periods of time and replicated to guarantee reliability.

Accordingly, the application server 124 may provide data and process redundancy, in which data processing and data storage may be scaled in response to demand. Further, in a networked deployment, new servers may be added. Thus, the application server 124 can include a plurality of physical machines that may be grouped together and presented as a single computing system. Each physical machine of the plurality of physical machines may comprise a node in a cluster. The application server 124 may also be in the form of virtual machines, such as virtual engines (VE) and virtual private servers (VPS).

The user equipment 102A-102B can communicate with the application server 124 utilizing one or more wireless base stations 114 or any other common wireless or wireline network access technologies. The user equipment 102A-102B can be devices operated via customers such as smartphones, mobile devices, personal digital assistants (PDAs), or other electronic devices having a wireless communication function that are capable of receiving inputs, processing the inputs, and generating output data. Accordingly, the user equipment 102A-102B can comprise a web browser 104 and a messaging application 106 installed thereon. The messaging application 106 can comprise various messaging systems such as Short Message Service (SMS), email, instant messaging (IM), or other messaging systems that are capable of receiving and propagating video, audio, images, and uniform resource locators (URLs) of a variety of different content. The messaging application 106 is configured to transmit outgoing messages 110 to one or more user equipment and receive incoming messages 112 from one or more user equipment, wherein the outgoing messages 110 and incoming messages 112 can comprise a link to a URL.

The application server 124 provides a URL preview tool 108. The URL preview tool 108 is configured to identify and validate a shared URL that is included in transmitted messages via user equipment 102A-102B. The URL preview tool 108 may retrieve, scrape, and/or parse the HTML or other markup language information of a website corresponding to or referenced in the shared URL. As shown in the illustrated embodiment, one or more websites can be hosted on a web server 126 connected to the Internet 118. Accordingly, the web server 126 can provide the HTML or the markup language information corresponding to each respective website upon receiving a request from the application server 124 via the URL preview tool 108. Each webpage on a website corresponds to a URL 128A-128B or is referenced in the URL 128A-128B. Additionally, each webpage on a website comprises digital content thereon, including, without limitation, a title 130, a description of the website 132, and an image 134 (e.g., thumbnail image, header image, profile image, etc.). Each content can be tagged or identified by a defined content field included in the HTML. The URL preview tool 108 can implement various parsing techniques in order to browse the HTML and extract relevant information such as a selection of content corresponding to defined content fields. Parsed content obtained from the HTML is used to generate a URL preview for display, thereby enticing users to click on a link to the URL and view content referenced in the URL.

In various embodiments, the URL preview tool 108 can implement a selection algorithm when two or more types of content are tagged or identified by a single defined content field in order to determine which content to utilize to generate a URL preview. For example, the HTML can include two or more images (e.g., a header image of a website and a favicon of the website) under a content field for images. Based at least partially on the selection algorithm, the URL preview tool 108 can select the header image instead of the favicon to display in the URL preview.

Additionally, the selection algorithm can define a set of defined content fields to locate in the HTML. Thus, a URL preview can comprise a specific type of content, thereby limiting the URL preview to deliver succinct information that can be digested quickly. For example, the selection algorithm can enable the URL preview tool 108 to locate only the content fields for title and image. In this way, the URL preview tool 108 can scan for the title and image in the HTML of a website, and then display the obtained title and image content in a URL preview. Moreover, the selection algorithm can include conditional statements to enable the URL preview tool 108 to locate certain content fields. For example, the selection algorithm can enable the URL preview tool 108 to locate the description of the website only if no images are available in the HTML.

In various embodiments, the URL preview tool 108 can implement a lookup table to determine which information to include in generated previews. For example, parsed content of a website can be cached or saved in the lookup table such that the lookup table comprises the HTML file. For example, if the URL preview tool 108 retrieves a title 130 and a thumbnail image 134 from a website, the URL preview tool 108 can save the title 130 and the thumbnail image 134 in a lookup table and display a preview comprising the title 130 and the thumbnail image 134 via a graphical user interface (GUI) of a messaging application 106 running on one or more user equipment 102A-102B. Similarly, if the URL preview tool 108 retrieves only a title 130 from a website, the URL preview tool 108 can save the title 130 in the lookup table and display a preview comprising the title 130 via the GUI of the messaging application 106 running on one or more user equipment 102A-102B. In this regard, parsed content of a website can be marked as available in the lookup table. Content that is not found can be marked as unavailable or missing in the lookup table. Unavailable or missing content is not displayed in a URL preview. Content that is available in the lookup table can be selected in accordance with the selection algorithm for display. Thus, not all of the content available in the lookup able is necessarily displayed in the URL preview.

In various embodiments, the URL preview tool 108 can implement various authentication techniques if content is restricted on a website (e.g., a password-protected website, private content, etc.). For example, the URL preview tool 108 can implement multifactor authentication. Additionally, or alternatively, the web server 126 can utilize whitelisting in order to allow the application server 124 or the URL preview tool 108 to access websites.

### Example Computing Device Components

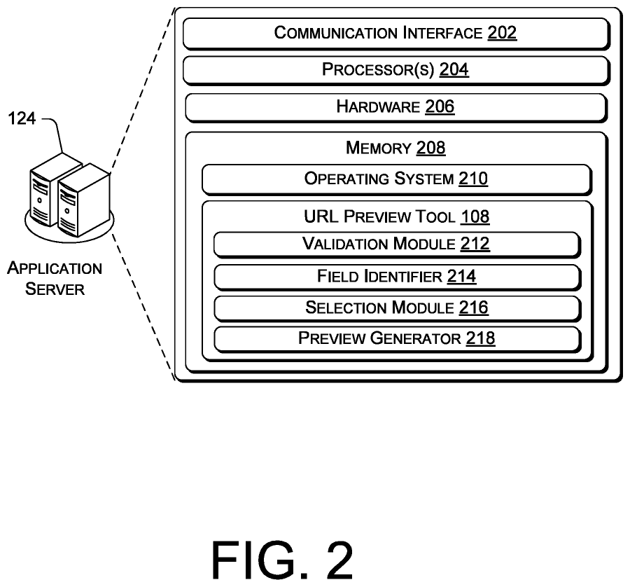

FIG. 2 is a block diagram showing various components of an illustrative computing device, wherein the computing device can comprise an application server 124. It is noted that the application server 124 as described herein can operate with more or fewer of the components shown herein. Additionally, the application server 124 as shown herein or portions thereof can serve as a representation of one or more of the computing devices of the present system.

The application server 124 may include a communication interface 202, one or more processors 204, hardware 206, and memory 208. The communication interface 202 may include wireless and/or wired communication components that enable the application server 124 to transmit data to and receive data from other networked devices. In at least one example, the one or more processor(s) 204 may be a central processing unit(s) (CPU), graphics processing unit(s) (GPU), both a CPU and GPU or any other sort of processing unit(s). Each of the one or more processor(s) 204 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 204 may also be responsible for executing all computer applications stored in the memory, which can be associated with common types of volatile (RAM) and/or non-volatile (ROM) memory. The hardware 206 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 208 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 208 may also include a firewall. In some embodiments, the firewall may be implemented as hardware 206 in the application server 124.

The processors 204 and the memory 208 of the application server 124 may implement an operating system 210 and a URL preview tool 108. The operating system 210 may include components that enable the application server 124 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The URL preview tool 108 comprises a validation module 212, a field identifier 214, a selection module 216, and a preview generator 218. The URL preview tool 108 receives a message authored by a user operating a user equipment, wherein the message comprises a shared URL. Upon receiving an incoming message, the validation module 212 is configured to determine whether the shared URL refers to an existing website and further validate whether or not the shared URL comprises invalid characters or incorrect characters. If the shared URL is valid, the URL preview tool 108 retrieves from a web server, markup language information (e.g., HTML) corresponding to a website referenced in the shared URL. The markup language information includes various website content (e.g., URL, title, description, image, author, publishers, etc.), wherein each content can correspond to a predefined content field or tag.

In various embodiments, the field identifier 214 can implement web crawler techniques in order to browse the retrieved markup language information for a set of predefined content fields. Additionally, the field identifier 214 can implement a parser to extract relevant information such as content corresponding to the defined content fields. The selection module 216 can implement a selection algorithm that is configured to select the website content for displaying a URL preview in the messaging application based partially on the predefined content fields identified in the markup language information. For example, the selection module 216 can select one of a plurality of images to display in the URL preview. Additionally, the selection module 216 can define a set of defined content fields (e.g., utilizing conditional statements) to locate in the HTML or the markup language information.

The field identifier 214 can provide the identified predefined content fields and corresponding content to the preview generator 218 in order to generate a URL preview utilizing the content. In various embodiments, the preview generator 218 can define a preview display format specifying the placement of each of the website content in a graphical user interface (GUI) of the messaging application. For example, the preview display format can specify the minimum image size and the maximum number of characters allowed for a description and a title.

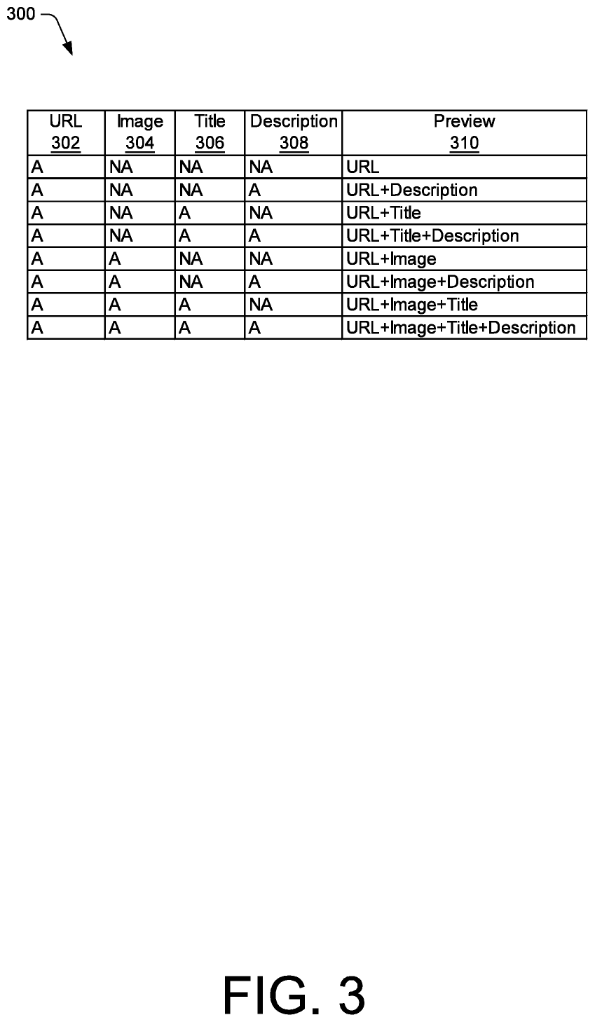

The preview generator 218 can refer to a lookup table to provide a URL preview, wherein the lookup table can be stored in a data store. An example lookup table 300 is depicted in FIG. 3. The lookup table 300 can comprise a set or a list of predefined content fields that are in the markup language information of a website that corresponds to the URL shared in an outgoing message. In the illustrated embodiment, the lookup table 300 includes a URL field 302, an image field 304, a title field 306, and a description field 308. If the markup language information of a website comprises content corresponding to the content field, the lookup table 300 designates that the content is available. For illustration purposes only, it is noteworthy that in FIG. 3, content that is available is denoted with an “A” and content that is not available is denoted with an “NA.” If the markup language information does not comprise content corresponding to the content field, the lookup table 300 designates that the content is not available. The preview generator 218 can display a URL preview 310 using the available content. For example, if the URL 302 is available, but the image 304, title 306, and the description 308 are not available, the URL preview 310 comprises only the URL. If the URL 302 and the title 306 are available but the image and the description are not available, the URL preview 310 comprises only the URL and the title.

In various embodiments, the field identifier 214 can identify content fields within the markup language information based at least partially on a selection algorithm as determined by the selection module 216. Additionally, the preview generator 218 can utilize defined content fields from the selection module 216 to generate a URL preview. Thus, the selection module 216 can determine which available content to utilize from the lookup able for the URL preview.

### Example User Interface

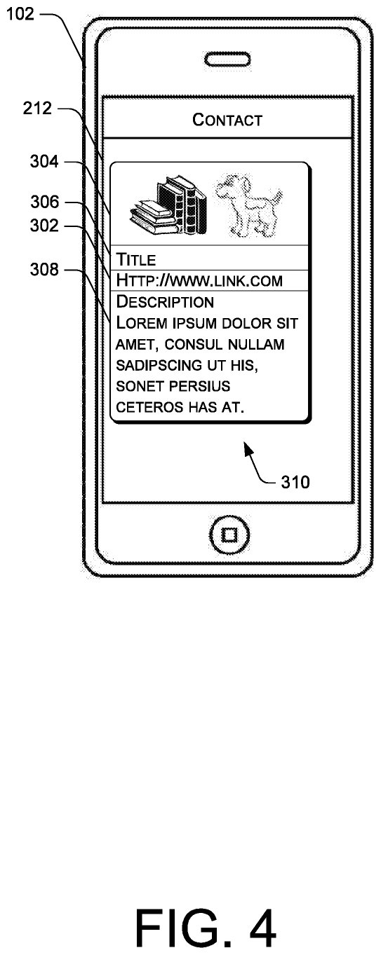

FIG. 4 is an example graphical user interface (GUI) of a messaging application showing a URL preview 310. It is noted that the user equipment 102 can utilize any of a number of advantageous interfaces, including an SMS interface, an instant messaging interface, an email-based interface, an application programming interface (API) function-based interface, and/or so forth. In the illustrated embodiment, the URL preview 310 includes a URL 302, an image 304, a title 306, and a description 308 of a website referenced in the URL 302. It is noted that the image 304 can also comprise graphics interchange formats (GIFs), clips, videos, and/or so forth.

The URL preview tool can define the minimum size of the image required, the maximum size of the image allowed, and the maximum number of characters to be displayed. Additionally, the URL preview tool can define the placement of each content 302-308. For instance, the URL preview tool can specify that the image should be located on the top and the description should be located on the bottom of the preview. If the image is not available, the URL preview tool can specify that the title should be located on the top of the preview. Additionally, or alternatively, the URL preview tool can display a default image as a placeholder if the image content from the website is not available. Similarly, if the description 308 is not available, the URL 302 is located at the bottom of the preview.

In various embodiments, the URL preview 310 can be displayed in the GUI in place of the URL in the incoming message and/or the outgoing message. For example, if an incoming message comprises only the URL, the text of the URL can be replaced with the URL preview 310. In this way, a user can view the URL and a preview of content referenced in the URL in a convenient manner without having to click on a link to the URL. Additionally, the URL preview 310 can comprise a link to the URL such that when a user clicks or taps on the URL preview 310, the user is directed to the URL. In various embodiments, the URL preview tool can define a linked object, such as the image 304. In this way, the user is directed to the URL only when the user clicks or taps on the image.

### Example Processes

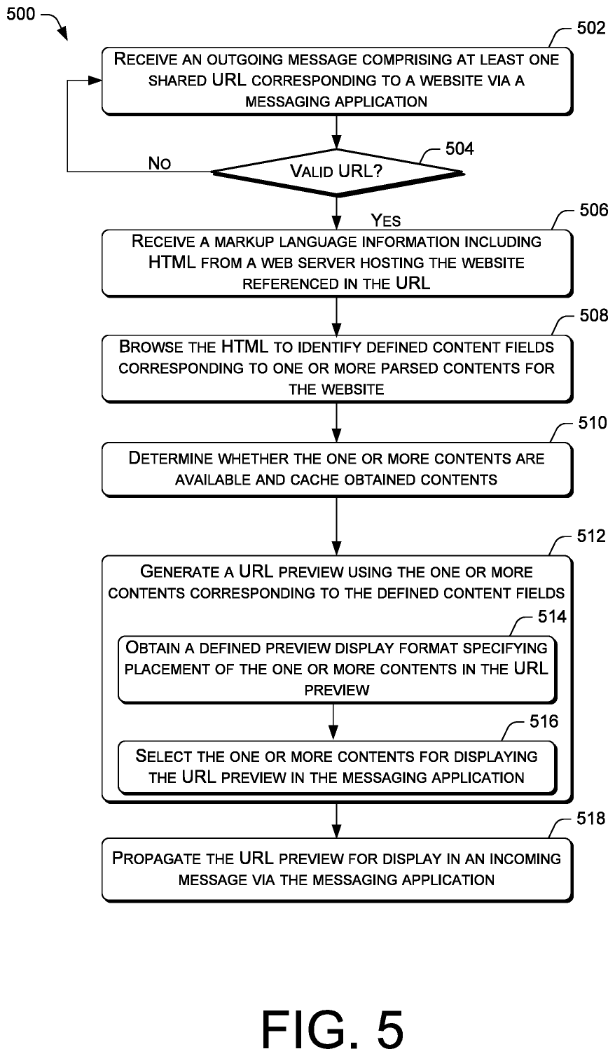

FIG. 5 presents an illustrative process 500 for generating URL previews in messaging applications. The process 500 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process 500 is described with reference to the network 100 of FIG. 1.

FIG. 5 is a flow diagram of an example process 500 for generating URL previews in a messaging application from the perspective of the application server. At block 502, the application server receives an outgoing message comprising at least one shared URL corresponding to a website via a messaging application. The outgoing message can be authored by a first user operating a first user equipment. At decision block 504, the validation module of the URL preview tool determines whether the URL is valid. More specifically, the validation module ensures that the website referenced in the URL is an existing website and that the URL does not comprise incorrect or invalid characters.

If the URL is valid (“yes” response from the decision block 504), the server receives a markup language information (e.g., HTML) from a web server hosting the website, as shown in block 506. In this regard, the application server can transmit a request for the markup language information to the web server. If the website is restricted, the web server can authenticate the application server utilizing various authentication protocols. For example, the application server can implement whitelisting and/or blacklisting.

At block 508, a field identifier 214 of the URL preview tool can browse the HTML to identify defined content fields corresponding to at least one content for the website. In various embodiments, the content fields can be defined by the URL preview tool, which may implement a selection algorithm. For example, the defined content fields can include the URL, a title, a description, and an image of the website. At block 510, the field identifier 214 determines whether or not the at least one content is available in the markup language information or the HTML. In various embodiments, the field identifier 214 can also conduct content caching utilizing one or more data stores. In this way, the field identifier 214 can reference a lookup table comprising the HTML file to determine whether at least one content is available. At block 512, the preview generator 218 of the URL preview tool generates a URL preview using the at least one content corresponding to the defined content fields.

More specifically, at block 514, the preview generator obtains a defined preview display format that specifies the placement of the at least one content in the URL preview. In various embodiments, the preview generator can obtain the preview display format from the messaging application. Alternatively, the preview generator itself can define the preview display format. At block 516, the selection module 216 of the URL preview tool can select the at least one content for displaying the URL preview in the messaging application. At block 518, the URL preview tool can propagate the generated URL preview for display in an incoming message via the messaging application. The incoming message can be received by a second user operating a second user equipment. In various embodiments, the generated URL preview can also be displayed in an outgoing message via the messaging application.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
receiving, from a first user equipment, a message comprising a link to a uniform resource locator (URL) corresponding to a website hosted on a web server, wherein the message is transmitted via a messaging application;
obtaining, from the web server, a markup language information of the website;
browsing the markup language information to locate a set of predefined content fields, each predefined content field specifying a website content;
selecting the website content for displaying a URL preview in the messaging application based partially on the set of predefined content fields identified in the markup language information; and
propagating the message comprising the URL preview to a second user equipment.

2. The one or more non-transitory computer-readable media of claim 1, wherein the acts further comprise:
validating the URL to confirm that the URL references an existing website.

3. The one or more non-transitory computer-readable media of claim 1, wherein the markup language information comprises hypertext markup language (HTML).

4. The one or more non-transitory computer-readable media of claim 1, wherein the website content corresponding to one of the set of predefined content fields identified in the markup language information is stored in a lookup table.

5. The one or more non-transitory computer-readable media of claim 1, wherein the messaging application includes any of the following: email, Short Message Service (SMS), and instant messaging (IM).

6. The one or more non-transitory computer-readable media of claim 1, wherein the website content comprises a website URL, a website title, a website description, and a website image.

7. The one or more non-transitory computer-readable media of claim 1, wherein the one or more non-transitory computer-readable media comprises an on-premise server.

8. The one or more non-transitory computer-readable media of claim 1, wherein the website content is publicly available.

9. The one or more non-transitory computer-readable media of claim 1, wherein the acts further comprise:
generating the URL preview based at least partially on a preview display format specifying a placement of the website content in a graphical user interface (GUI) of the messaging application.

10. The one or more non-transitory computer-readable media of claim 1, wherein the acts further comprise:
propagating the message comprising the URL preview to the first user equipment.

11. A computer-implemented method, comprising:
receiving a message authored by a user, the message comprising a link to a uniform resource locator (URL) corresponding to a website hosted on a web server, and a request from the user to share the link to the URL via a messaging application;
responsive to the request:
retrieving a markup language information corresponding to the website from the web server, wherein the markup language information comprises a set of predefined content fields, each predefined content field specifying a website content;
browsing the markup language information to locate the set of predefined content fields in order to obtain the website content;
selecting the website content to generate a URL preview for display in the messaging application; and
serving the link and the generated URL preview comprising the website content.

12. The method of claim 11, wherein the messaging application is configured to define a preview display format specifying a placement of the website content in a graphical user interface (GUI) of the messaging application.

13. The method of claim 11, wherein the website content is public.

14. The method of claim 11, wherein the request utilizes a multifactor authentication.

15. The method of claim 11, further comprising:
receiving an authorization to obtain the website content using a whitelist.

16. The method of claim 11, further comprising:
parsing the website content corresponding to the set of predefined content fields.

17. A system, comprising:
one or more nontransitory storage mediums configured to provide stored code segments, the one or more nontransitory storage mediums coupled to one or more processors, each configured to execute the stored code segments and causing the one or more processors to:
receive a message comprising a link to a uniform resource locator (URL) corresponding to a website hosted on a web server, wherein the message is transmitted via a messaging application, and a request to share the message comprising the link to the URL with one or more user equipment;
obtain, from the web server, a markup language information of the website, the markup language information comprising a set of predefined content fields, each predefined content field specifying at least one website content;
locate the set of predefined content fields to obtain the at least one website content; and
propagate the message comprising the link to the URL and the at least one website content.

18. The system of claim 17, whereinto propagating the message further comprises:
selecting the at least one website content based at least partially on an availability of the at least one website content;
defining a preview display format specifying a placement of the at least one website content in a graphical user interface (GUI) of the messaging application; and
generating a URL preview comprising the at least one website content based at least partially on the preview display format.

19. The system of claim 17, wherein the web server is configured to perform at least one of blacklisting and whitelisting.

20. The system of claim 17, wherein the request utilizes an identifier correlating with an account that is associated with a plurality of user equipment and a plurality of users.
